(19) United States
(12) Patent Application Publication
(10) Pub. No.: US 2007/0035131 A1
(43) Pub. Date: Feb. 15, 2007

(54) Expandable tubular connection

(75) Inventor: Scott A. Benzie, Houston, TX (US)

Correspondence Address: STREETS & STEELE, 13831 NORTHWEST FREEWAY, SUITE 355, HOUSTON, TX, 77040, US

(73) Assignee: Grinaldi LTD

(21) Appl. No.: 11/201,792

(22) Filed: Aug. 11, 2005

(51) Int. Cl. F16L 25/00

(52) U.S. Cl. 285/333

(57) ABSTRACT

A radially-expandable tubular connection comprises a radially-expandable box member and a radially expandable pin member. The box member has an internal thread, and a non-threaded internal seal surface. The pin member has an external thread for threadably engaging the internal thread of the box member, and a non-threaded external seal surface for engaging the internal seal surface of the box member. One of the internal and external seal surfaces comprises a protuberance in the respective box member or pin member. Accordingly, radial expansion of the tubular connection when the internal thread is threadably engaged within the external thread urges the protuberance of the one seal surface into contact with the other seal surface.

### BACKGROUND OF THE INVENTION

1. Field of the Invention

The present invention relates to threaded tubular connections for use in the drilling of wellbores (also known as boreholes) and production of hydrocarbons therefrom. More particularly, the invention relates to threaded connections for downhole tubulars that are designed to be plastically, radially expanded in a wellbore.

2. Background of the Related Art

In the construction, drilling, and/or repair of wellbores, it may be advantageous to use radially-expandable tubulars (also referred to herein as tubular members). The in-situ radial expansion of such tubulars allows for the minimization of conventional reductions (with depth) in wellbore diameter, as well as the isolation of low or high pressure areas in the wellbore, among other things.

Casing joints, liners and other oilfield tubulars are usually connected in an end-to-end manner by threaded connections. The connections may be designed to provide mechanical integrity between the joints and a seal between the interior and exterior of the tubular connection. The seal may be a metal-to-metal seal, an elastomeric seal, a thread seal (e.g., a thread compound seal), or a combination of seals.

When a threaded tubular connection is plastically radially expanded, the male (pin) and the female (box) portions or members of the connection typically undergo different degrees of plastic deformation, both in longitudinal and radial directions. This difference can cause different degrees of radial displacements after expansion and the creation of gaps between the pin and box members of the connection. As a result, the seal surfaces in contact before radial expansion can become separated after expansion.

One attempt to solve this “gap” problem is described in U.S. Pat. No. 6,607,220, and is shown in prior art FIGS. 1A-1B. Thus, a strain-focusing groove 122 of a box member 120 is said to be deformable, under radial expansion induced by a mechanical expansion tool (i.e., a mandrel) moving in direction 110, to produce a seal (see FIG. 1B) with a seal surface 152 of a pin member 150. This sealing mechanism is limited, however, to threaded tubular connections employing so-called wedge threads, and experience suggests that the alleged seal between surfaces 122, 152 is unreliable (the surface 152 “springs back” upon removal of the radial expansion force)—particularly when the radial expansion is induced by internal fluid pressure in the connection.

Therefore, a need exists for a reliable, radially-expandable threaded connection that is capable of providing/maintaining one or more seals after radial expansion by different methods.

### DEFINITIONS

Certain terms are defined throughout this description as they are first used, while certain other terms used in this description are defined below:

“Box member” refers to an end portion of a tubular member employing a female threadform.

“Pin member” refers to an end portion of a tubular member employing a male threadform. The threadable engagement of a pin member within a box member is commonly called a threaded tubular connection, or simply a threaded connection or a tubular connection.

“Protuberance” means a component or element thrusting out from a surrounding or adjacent surface, e.g., as a rounded mass.

“Thread” means a ridge of generally uniform section in the form of a helix on the internal or external surface of a tubular member such as a pipe.

“Threadform” means the profile of a thread in an axial (longitudinal) section or plane for a length of one pitch.

“Tubular member” comprises a joint of pipe (e.g., a casing joint) or a coupling.

### SUMMARY OF THE INVENTION

The above-described needs, problems, and deficiencies in the art, as well as others, are addressed by the present invention in its various aspects and embodiments. In one aspect, the present invention provides a radially-expandable tubular connection, comprising a radially-expandable box member and a radially expandable pin member. The box member has an internal thread, and a non-threaded internal seal surface. The pin member has an external thread for threadably engaging the internal thread of the box member, and a non-threaded external seal surface for engaging the internal seal surface of the box member. One of the internal and external seal surfaces comprises a protuberance pre-formed in the respective box member or pin member. Accordingly, radial expansion of the tubular connection when the internal thread is threadably engaged within the external thread urges the protuberance of the one seal surface into contact with the other seal surface.

In particular embodiments, the internal seal surface comprises the protuberance. In other embodiments, the external seal surface comprises the protuberance.

Furthermore, in particular embodiments, the protuberance has a profile that is substantially circular or elliptical. The protuberance may have an axial length in the range of substantially 0.4 to substantially 1.5 inches, and a radial width in the range of substantially 0.03 to substantially 0.12 inches. More particularly, the protuberance preferably has an axial length in the range of substantially 0.5 to substantially 1.1 inches, and a radial width in the range of substantially 0.05 to substantially 0.10 inches.

In particular embodiments, the pin member comprises an elongated nose between the external thread and a free end of the pin member. The elongated pin nose of such embodiments comprises the external seal surface. Accordingly, the box member of such embodiments comprises a non-threaded internal seal surface. The elongated pin nose preferably has a length in the range of substantially 0.5 to substantially 2.0 inches.

In particular embodiments, the radially-expandable box member has a pair of separated internal threads, and the non-threaded internal seal surface is formed intermediate the internal threads. In such embodiments, the radially-expandable pin member has a pair of separated external threads for threadably engaging the respective pair of internal threads, and the non-threaded external seal surface is formed intermediate the external threads for engaging the internal seal surface. Accordingly, the protuberance will also be disposed between the separated thread sets.

In another aspect, the present invention provides a method for making a radially-expandable tubular connection, comprising the steps of making a radially-expandable box member, and making a radially-expandable pin member. The box member is made by forming a thread in an internal surface of a box member, and forming a non-threaded internal seal surface on the box member adjacent the internal thread. The pin member is made by forming a thread in an external surface of a pin member that complements the internal thread of the box member, and forming a non-threaded external seal surface on the pin member adjacent the external thread that complements the non-threaded internal seal surface of the box member. The method further comprises the step of forming a protuberance in one of the internal and external seal surfaces.

In particular embodiments, the method further comprises the step of threadably engaging the external thread of the pin member within the internal thread of the box member to form an expandable tubular connection. The resulting expandable tubular connection maybe radially expanded to produce deformation of the one seal surface that urges the protuberance into contact with the other seal surface.

### BRIEF DESCRIPTION OF THE DRAWINGS

A more particular description of the invention, briefly summarized above, is provided by reference to embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1A shows a fragmentary sectional view of a prior art radially-expandable, threaded tubular connection.

FIG. 1B shows a fragmentary sectional view of the threaded tubular connection of FIG. 1A, after radial expansion thereof.

FIG. 2A shows a fragmentary sectional view of a radially-expandable, threaded tubular connection employing a protuberant seal surface on a box member in accordance with the present invention.

FIG. 2B shows a fragmentary sectional view of the threaded tubular connection of FIG. 2A, after radial expansion thereof.

FIG. 3A shows a fragmentary sectional view of a radially-expandable, threaded tubular connection employing a protuberant seal surface on a pin member in accordance with the present invention.

FIG. 3B shows a fragmentary sectional view of the threaded tubular connection of FIG. 2A, after radial expansion thereof.

FIG. 4 shows a fragmentary sectional view of an alternative radially-expandable, threaded tubular connection employing a protuberant seal surface on a box member in accordance with the present invention.

FIG. 5 shows a fragmentary sectional view of an alternative radially-expandable, threaded tubular connection employing a protuberant seal surface on a pin member in accordance with the present invention.

FIG. 6 shows a fragmentary sectional view of a further alternative radially-expandable, threaded tubular connection employing a protuberant seal surface on a box member in accordance with the present invention.

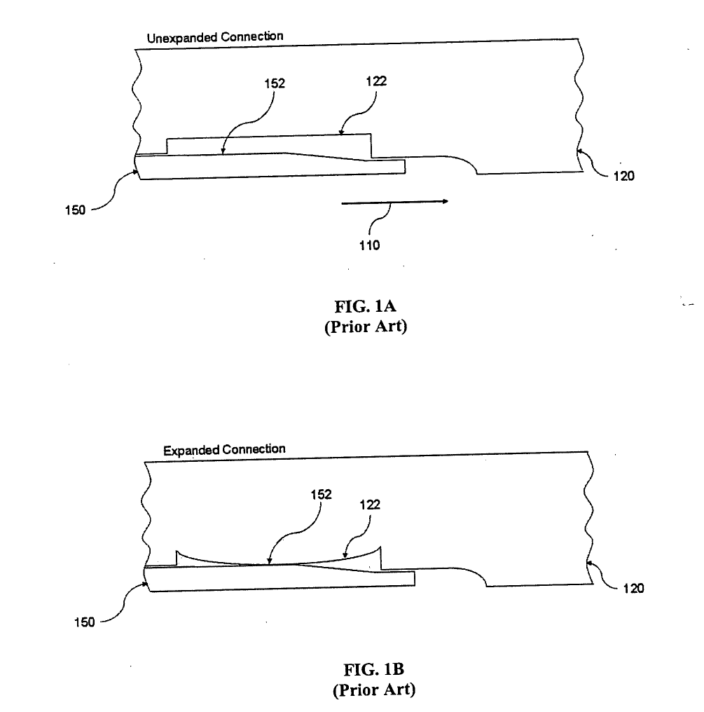

### DETAILED DESCRIPTION OF THE INVENTION

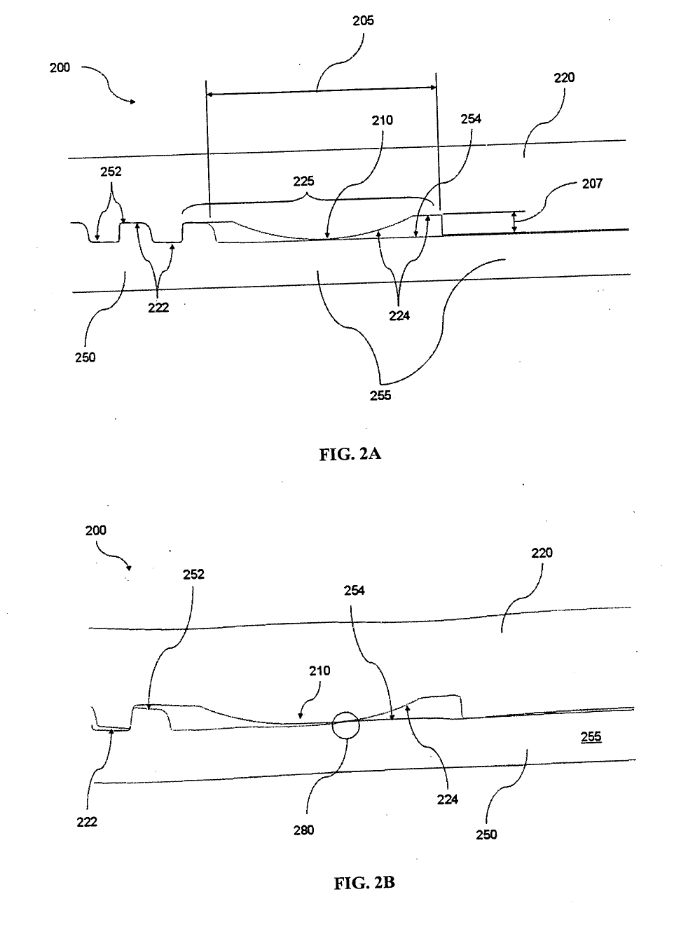

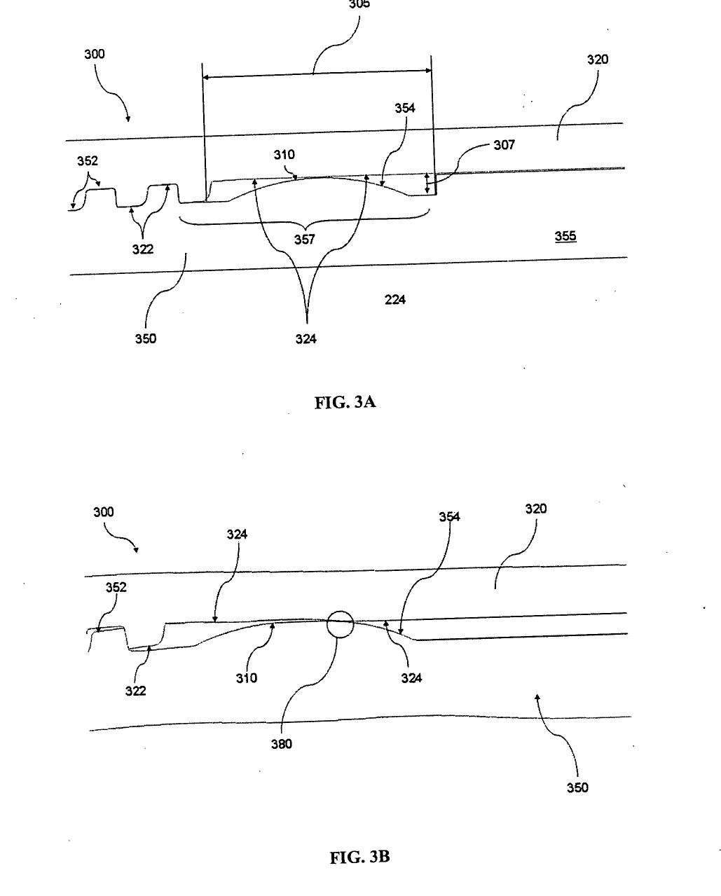

FIG. 2A shows a fragmentary sectional view of a radially-expandable, threaded tubular connection 200, comprising a radially-expandable box member 220 and a radially expandable pin member 250. The box member 220 has an internal thread 222, and a non-threaded recess 225. The recess 225 comprises an internal seal surface 224. The internal seal surface 224 is complex, and comprises a protuberance 210 pre-formed in the box member 220. It will be appreciated, however, that an external seal surface on the pin member may comprise the protuberance, as is illustrated in FIGS. 3A-3B (described below).

The protuberance 210 preferably comprises a positive curvature and for practical reasons has a profile (i.e., when viewed in section as shown in FIG. 2A) that is substantially circular or elliptical in nature. The protuberance may employ various geometries, but advantageously is formed to have an axial length (referenced as 205) in the range of substantially 0.4 to substantially 1.5 inches, and a radial width (referenced as 207) in the range of substantially 0.03 to substantially 0.12 inches. More particularly, it is presently preferred that the protuberance have an axial length in the range of substantially 0.5 to substantially 1.1 inches, and a radial width in the range of substantially 0.05 to substantially 0.10 inches. These dimensions are adapted to standard wellbore casing diameters (e.g., 7.625 inches), but are also suitable for use in other casing sizes as well as other expandable tubulars.

The pin member 250 has an external thread 252 for threadably engaging the internal thread 222 of the box member 220, and an elongated nose 255 extending between the external thread 252 and a free end (not shown) of the pin member. The elongated pin nose 255 comprises a non-threaded external seal surface 254 that opposes the internal seal surface 224 of the box member for engagement therewith, both before and after radial expansion. The elongated pin nose 255 preferably has a length in the range of substantially 0.5 to substantially 2.0 inches.

Accordingly, with reference now to FIG. 2B, radial expansion of the tubular connection 200 when the internal thread 222 is threadably engaged within the external thread 252 urges the protuberance 210 of the internal seal surface 224 into contact with the external seal surface 254. The protuberance (or protuberant seal surface) 210 accommodates the differing degrees of plastic deformation experienced by the box member 220 and the pin member 250 under the radial expansion of the connection 200, particularly when formed according to the dimensional ranges for length 205 and width 207 set forth above. The shape of the protuberance 210 localizes the plastic radial stresses caused by radial expansion of the connection 200, resulting in high interference stresses between the protuberance 210 and the elongated pin nose 255—particularly in the localized area 280. Accordingly, the internal seal surface 224 and the external seal surface 254 contact each other under the application of a radial expansion force within the connection 200, and undergo sufficient plastic deformation to maintain a high pressure seal after the radial expansion force is removed (be it mechanical or fluid-based).

The radially-expandable box member 220 is made by forming the thread 222 in an internal surface thereof generally adjacent an open end (not shown) thereof, and forming the non-threaded internal seal surface 224 on the box member adjacent the internal thread 222. The internal seal surface 224 is formed so as to comprise the protuberance 210 in the box member 220, as described in greater detail above.

The pin member 250 is made by forming the thread 252 in an external surface thereof generally adjacent an open end (not shown) thereof that complements the internal thread 222 of the box member 252. The non-threaded external seal surface 254 is formed on the pin member 250 adjacent the external thread 252 that complements the non-threaded internal seal surface 224 of the box member.

FIG. 3A shows a fragmentary sectional view of a radially-expandable, threaded tubular connection 300 according to the present invention. The connection 300 comprises a radially-expandable box member 320 and a radially expandable pin member 350. The box member 320 has an internal thread 322, and an internal seal surface 324.

The pin member 350 has an external thread 352 for threadably engaging the internal thread 322 of the box member 320, and an elongated nose 355 extending between the external thread 352 and a free end (not shown) of the pin member. The elongated pin nose 355 comprises a non-threaded recess 357. The recess 357 comprises an external seal surface 354 that opposes the internal seal surface 324 of the box member for engagement therewith, both before and after radial expansion. The elongated pin nose 355 preferably has a length in the range of substantially 0.5 to substantially 2.0 inches. The external seal surface 354 is complex, and comprises a protuberance 310 pre-formed in the pin member 350.

The protuberance 310 preferably comprises a positive curvature and for practical reasons has a profile (i.e., when viewed in section as shown in FIG. 3A) that is substantially circular or elliptical in nature. The protuberance may employ various geometries, but advantageously is formed to have an axial length (referenced as 305) in the range of substantially 0.4 to substantially 1.5 inches, and a radial width (referenced as 307) in the range of substantially 0.03 to substantially 0.12 inches. More particularly, it is presently preferred that the protuberance have an axial length in the range of substantially 0.5 to substantially 1.1 inches, and a radial width in the range of substantially 0.05 to substantially 0.10 inches. These dimensions are adapted to standard wellbore casing diameters (e.g., 9.625 inches), but are also suitable for use in other casing sizes as well as other expandable tubulars.

Accordingly, with reference now to FIG. 3B, radial expansion of the tubular connection 300 when the internal thread 322 is threadably engaged within the external thread 352 urges the protuberance 310 of the external seal surface 354 into contact with the internal seal surface 324. The protuberance (or protuberant seal surface) 310 accommodates the differing degrees of plastic deformation experienced by the box member 320 and the pin member 350 under radial expansion of the connection 300, particularly when formed according to the dimensional ranges for length 305 and width 307 set forth above. The shape of the protuberance 310 localizes the plastic radial stresses caused by radial expansion of the connection 300, resulting in high interference stresses between the protuberance 310 and the internal seal surface 324—particularly in the localized area 380. Accordingly, the internal seal surface 324 and the external seal surface 354 contact each other under the application of a radial expansion force within the connection 300, and undergo sufficient plastic deformation to maintain a high pressure seal after the radial expansion force is removed (be it mechanical or fluid-based).

The pin and box members 350, 320 are made in similar fashion to that described above for the pin and box members 250, 220, except in the former the protuberance 310 is formed on the external seal surface 354 of the pin member.

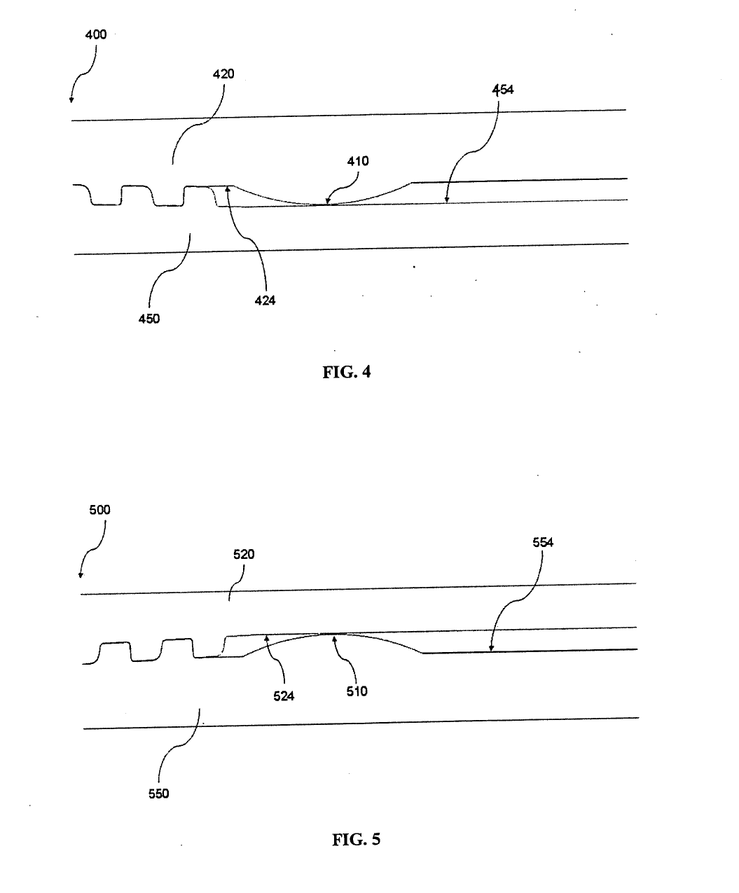

It will be appreciated by those skilled in the art that the protuberance, or protuberant seal surface, described herein may be employed in various different ways. Thus, FIG. 4 shows a fragmentary sectional view of a radially-expandable, threaded tubular connection 400 employing a protuberant seal surface 410 formed in an internal seal surface 424 on a box member 420 for establishing/maintaining a seal with an external seal surface 454 of a pin member 450. Similarly, FIG. 5 shows a fragmentary sectional view of a radially-expandable, threaded tubular connection 500 employing a protuberant seal surface 510 formed in an external seal surface 554 on a pin member 550 for establishing/maintaining a seal with an internal seal surface 524 of a box member 520. The embodiments of FIGS. 4-5 demonstrate that the protuberant seal need not be set within particular recessed areas (see, e.g., recess 225 of FIG. 2A and recess 357 of FIG. 3A), but may be employed to advantage in other ways.

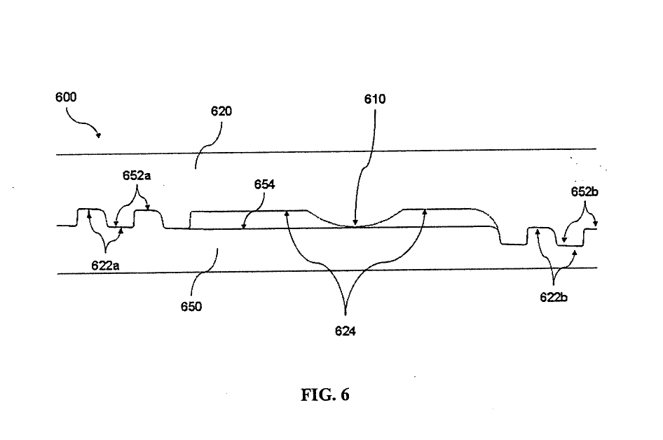

A still further example is provided by FIG. 6, which shows a fragmentary sectional view of a radially-expandable, threaded tubular connection 600 employing a protuberant seal surface 610 formed in an internal seal surface 624 on a box member 620 for establishing/maintaining a seal with an external seal surface 654 of a pin member 650. The connection 600 differs primarily from the connection 400 of FIG. 4 in that connection 600 employs two separated sets of engaging internal and external threads (one set referenced as 622a, 652a; the other set referenced as 622b, 652b) on the respective box and pin members 620, 650. The separated thread sets bound the internal seal surface 624, including the protuberant seal surface 610 thereof, and the external seal surface 654.

It will be further appreciated by those skilled in the art that the pin and box members described herein may employ any conventional coatings such as, but not limited to, zinc phosphate, manganese phosphate, copper, or any other conventional surface treatments, such as grid blasting, to prevent galling and/or to improve corrosion resistance. Additionally, the threaded tubular connections described herein may comprise known frictional or pressure seal compounds such as, but not limited to, an anaerobic set compounds.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open set or group. Similarly, the terms “containing,” having,” and “including” are all intended to mean an open set or group of elements. “A,” “an” and other singular terms are intended to include the plural forms thereof unless specifically excluded. It is the express intention of the applicant not to invoke 35 U.S.C. § 112, paragraph 6 for any limitations of any of the claims herein, except for those in which the claim expressly uses the words “means for” together with an associated function.

What is claimed is:

1. A radially-expandable tubular connection, comprising:
a radially-expandable box member having
an internal thread, and
a non-threaded internal seal surface; and
a radially-expandable pin member having
an external thread for threadably engaging the internal thread, and
a non-threaded external seal surface for engaging the internal seal surface;
one of the internal and external seal surfaces comprising a protuberance pre-formed in the respective box member or pin member;
whereby radial expansion of the tubular connection when the internal thread is threadably engaged within the external thread urges the protuberance of the one seal surface into contact with the other seal surface.

2. The tubular connection of claim 1, wherein the protuberance has a profile that is substantially circular or elliptical.

3. The tubular connection of claim 1, wherein the protuberance has an axial length in the range of substantially 0.4 to substantially 1.5 inches.

4. The tubular connection of claim 3, wherein the protuberance has an axial length in the range of substantially 0.5 to substantially 1.1 inches.

5. The tubular connection of claim 1, wherein the protuberance has a radial width in the range of substantially 0.03 to substantially 0.12 inches.

6. The tubular connection of claim 5, wherein the protuberance has a radial width in the range of substantially 0.05 to substantially 0.10 inches.

7. The tubular connection of claim 1, wherein the pin member comprises an elongated nose between the external thread and a free end of the pin member, the elongated pin nose comprising the external seal surface, and the box member comprises the internal seal surface.

8. The tubular connection of claim 7, wherein the elongated pin nose has a length in the range of substantially 0.5 to substantially 2.0 inches.

9. The tubular connection of claim 7, wherein the internal seal surface comprises the protuberance.

10. The tubular connection of claim 7, wherein the external seal surface comprises the protuberance.

11. The tubular connection of claim 1, wherein:
the radially-expandable box member has
a pair of separated internal threads, and
the non-threaded internal seal surface is intermediate the internal threads; and
the radially-expandable pin member has
a pair of separated external threads for threadably engaging the respective pair of internal threads, and
the non-threaded external seal surface is intermediate the external threads for engaging the internal seal surface.

12. A method for making a radially-expandable tubular connection, comprising the steps of:
making a radially-expandable box member by
forming a thread in an internal surface of a box member,
forming a non-threaded internal seal surface on the box member; and
making a radially-expandable pin member by
forming a thread in an external surface of a pin member adjacent an open end of the pin member that complements the internal thread of the box member, and
forming a non-threaded external seal surface on the pin member adjacent the external thread that complements the non-threaded internal seal surface of the box member; and
forming a protuberance in one of the internal and external seal surfaces.

13. The method of claim 12, further comprising the steps of:
threadably engaging the external thread of the pin member within the internal thread of the box member to form an expandable tubular connection; and
radially expanding the expandable tubular connection to produce deformation of the one seal surface that urges the protuberance into contact with the other seal surface.

14. The method of claim 12, wherein the protuberance has a profile that is substantially circular or elliptical.

15. The method of claim 12, wherein the protuberance has an axial length in the range of substantially 0.4 to substantially 1.5 inches.

16. The method of claim 15, wherein the protuberance has an axial length in the range of substantially 0.5 to substantially 1.1 inches.

17. The method of claim 12, wherein the protuberance has a radial width in the range of substantially 0.03 to substantially 0.12 inches.

18. The method of claim 17, wherein the protuberance has a radial width in the range of substantially 0.05 to substantially 0.10 inches.

19. The method of claim 12, wherein the pin member comprises an elongated nose between the external thread and a free end of the pin member, the elongated pin nose comprising the external seal surface, and the box member comprises the internal seal surface.

20. The method of claim 19, wherein the elongated pin nose has a length in the range of substantially 0.5 to substantially 2.0 inches.

21. The method of claim 19, wherein the internal seal surface comprises the protuberance.

22. The method of claim 19, wherein the external seal surface comprises the protuberance.

23. The method of claim 12, wherein:
the step of making a radially-expandable box member comprises:
forming a pair of separated threads in an internal surface of a box member,
forming the non-threaded internal seal surface on the box member intermediate the internal threads; and
the step of making a radially-expandable pin member comprises:
forming a pair of separated thread in an external surface of a pin member that complement the respective internal threads of the box member, and
forming the non-threaded external seal surface on the pin member intermediate the external threads.

24. A radially-expandable tubular connection, comprising:
a radially-expandable box member having
an internal thread, and
a non-threaded internal seal surface; and
a radially-expandable pin member having
an external thread for threadably engaging the internal thread, and
a non-threaded external seal surface for engaging the internal seal surface;
one of the internal and external seal surfaces comprising a protuberant shape;
whereby radial expansion of the tubular connection when the internal thread is threadably engaged within the external thread urges the one protuberant seal surface into contact with the other seal surface.
